(19) United States
(12) Patent Application Publication
(10) Pub. No.: US 2026/0257670 A1
(43) Pub. Date: Sep. 3, 2026

(54) INFORMATION PROCESSING DEVICE, VEHICLE, INFORMATION PROCESSING METHOD, AND STORAGE MEDIUM

(71) Applicant: HONDA MOTOR CO., LTD., Tokyo (JP)

(72) Inventor: Yuki HARA, Tokyo (JP)

(73) Assignee: HONDA MOTOR CO., LTD., Tokyo (JP)

(21) Appl. No.: 19/551,639

(22) Filed: Feb. 27, 2026

(30) Foreign Application Priority Data
Mar. 3, 2025 (JP) 2025-032810

(51) Int. Cl. B60W 30/06; B60W 50/14; B60W 60/00

(52) U.S. Cl. CPC B60W 30/06; B60W 50/14; B60W 60/001; B60W 2050/146; B60W 2556/40; B60W 2556/45

(57) ABSTRACT

An information processing device transmits, to a vehicle that autonomously travels to a target parking position in a parking lot, first map information of the parking lot used for the autonomous travel. The information processing device includes a processor configured to: acquire scheduled travel route information indicating a scheduled travel route for the autonomous travel to the target parking position; refer to a storage unit configured to store the first map information for each of regions of the parking lot, to specify the first map information of a scheduled travel region including a section overlapping the scheduled travel route based on the scheduled travel route information; and transmit the first map information of the scheduled travel region to the vehicle.

### CROSS-REFERENCE TO RELATED APPLICATIONS

This application is based on and claims priority under 35 USC 119 from Japanese Patent Application No. 2025-032810 filed on March 3, 2025, the contents of which are incorporated herein by reference.

### TECHNICAL FIELD

The present invention relates to an information processing device, a vehicle, an information processing method, and a storage medium.

### BACKGROUND

In recent years, improvements in traffic safety have been required to enable inclusion, safety, toughness, and sustainability of urban and human residents. From a viewpoint of improving the traffic safety, for example, developments of driving assistance techniques and autonomous driving techniques for vehicles have been advanced.

Examples of the driving assistance techniques include a parking assistance technique for assisting a vehicle to park to a predetermined position (for example, Chinese Patent Publication No. 113525352 and Chinese Patent Publication No. 114937369). Further, U.S. Patent Application Publication No. 2023/0234561 below discloses a technique in which an area of each floor of a parking lot is divided into a plurality of parts based on a unit area, and a density in the parking lot is calculated based on the number of vehicles in each division unit area.

However, in the related art, there is room for improvement from a viewpoint of improving convenience for a user in a vehicle that autonomously travels in a parking lot using map information of the parking lot received from an external information processing device (for example, a server).

The present invention provides an information processing device, a vehicle, an information processing method, and a storage medium capable of improving convenience for a user in the vehicle that autonomously travels in a parking lot using map information of the parking lot received from the external information processing device.

### SUMMARY

A first aspect of the present disclosure relates to an information processing device for transmitting, to a vehicle that autonomously travels to a target parking position in a parking lot, first map information of the parking lot used for the autonomous travel. The information processing device includes: a processor configured to: acquire scheduled travel route information indicating a scheduled travel route for the autonomous travel to the target parking position; refer to a storage unit configured to store the first map information for each of regions of the parking lot, to specify the first map information of a scheduled travel region including a section overlapping the scheduled travel route based on the scheduled travel route information; and transmit the first map information of the scheduled travel region to the vehicle.

A second aspect of the present disclosure relates to a vehicle that autonomously travels to a target parking position in a parking lot using first map information of the parking lot received from an external information processing device. The vehicle includes: a processor configured to: receive information transmitted from the information processing device; and control travel of the vehicle. The processor is capable of receiving the first map information of a scheduled travel region including a section overlapping a scheduled travel route for the autonomous travel to the target parking position among a plurality of regions of the parking lot, and when receiving the first map information of the scheduled travel region, the processor performs the autonomous travel to the target parking position using the first map information of the scheduled travel region.

A third aspect of the present disclosure relates to an information processing method performed by a computer. The computer transmits, to a vehicle that autonomously travels to a target parking position in a parking lot, first map information of the parking lot used for the autonomous travel, and the information processing method includes; acquiring scheduled travel route information indicating a scheduled travel route for the autonomous travel to the target parking position; referring to a storage unit configured to store the first map information for each of regions of the parking lot, to specify the first map information of a scheduled travel region including a section overlapping the scheduled travel route based on the scheduled travel route information; and transmitting the first map information of the scheduled travel region to the vehicle.

A fourth aspect of the present disclosure relates to a non-transitory computer-readable storage medium storing program for causing a computer to execute a process. The computer transmits, to a vehicle that autonomously travels to a target parking position in a parking lot, first map information of the parking lot used for the autonomous travel, and the process includes: acquiring scheduled travel route information indicating a scheduled travel route for the autonomous travel to the target parking position; referring to a storage unit configured to store the first map information for each of regions of the parking lot, to specify the first map information of a scheduled travel region including a section overlapping the scheduled travel route based on the scheduled travel route information; and transmitting the first map information of the scheduled travel region to the vehicle.

According to the present invention, it is possible to provide an information processing device, a vehicle, an information processing method, and a storage medium capable of improving convenience for a user in the vehicle that autonomously travels in a parking lot using map information of the parking lot received from the external information processing device. This further improves safety of traffic and contributes to development of a sustainable transportation system.

### BRIEF DESCRIPTION OF DRAWINGS

Exemplary embodiments of the present invention will be described in detail based on the following figures, wherein:

FIG. 1 is a diagram showing an example of a parking assistance system 1 including a vehicle 100 and a server 200 according to the present embodiment;

FIG. 2 is a block diagram showing a configuration example of the vehicle 100;

FIG. 3 is a block diagram showing a configuration example of the server 200;

FIG. 4 is a diagram showing an example of a parking lot PA;

FIG. 5 is a sequence diagram showing an example of operations of the parking assistance system 1;

FIG. 6 is a diagram showing an example of a simplified map Mp displayed on a touch panel 22 of the vehicle 100;

FIG. 7 is a diagram showing an example of a scheduled travel route RT of the vehicle 100 in the parking lot PA;

FIG. 8 is a diagram showing a first example of transmission and reception of detailed map information DI between the server 200 and the vehicle 100;

FIG. 9 is a diagram showing a second example of the transmission and reception of the detailed map information DI between the server 200 and the vehicle 100;

FIG. 10 is a diagram showing a third example of the transmission and reception of the detailed map information DI between the server 200 and the vehicle 100;

FIG. 11 is a sequence diagram showing an example of the operations of the parking assistance system 1 according to a first modification;

FIG. 12 is a diagram showing an example of a newly scheduled travel route RTnew in the first modification;

FIG. 13 is a sequence diagram showing an example of the operations of the parking assistance system 1 according to a second modification; and

FIG. 14 is a sequence diagram showing an example of the operations of the parking assistance system 1 according to a third modification.

### DESCRIPTION OF EMBODIMENTS

Hereinafter, embodiments of an information processing device, a vehicle, an information processing method and a program of the present invention will be described with reference to the drawings.

The drawings are viewed in directions of reference numerals. The following embodiments do not limit the present invention, and not all of elements described in the following embodiments are necessary for the present invention. In the following description, the same or similar elements are denoted by the same or similar reference numerals, and a description thereof may be omitted or simplified.

### 1. Parking Assistance System

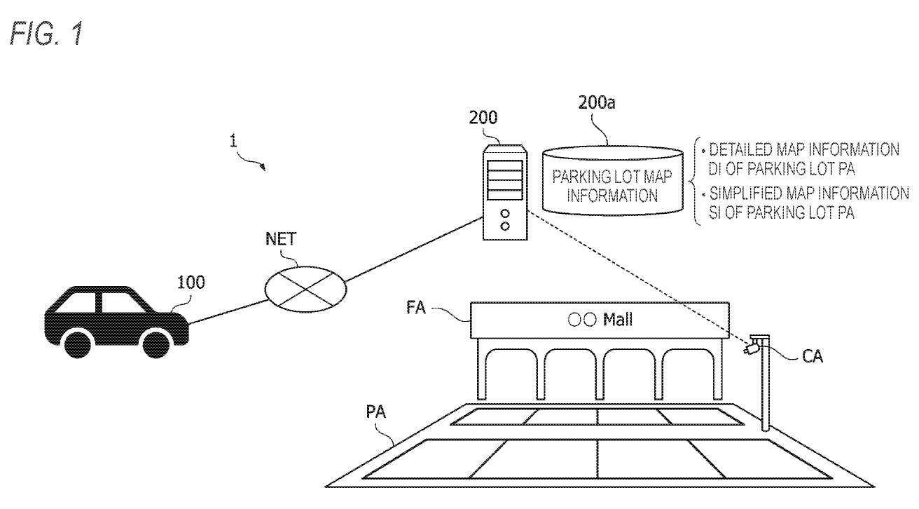

A parking assistance system 1 of the present embodiment shown in FIG. 1 includes at least one vehicle 100 and a server 200. In the parking assistance system 1, the vehicle 100 and the server 200 can communicate with each other via a communication network NET. The communication network NET is, for example, a mobile communication network such as so-called "4G" or "5G", or a wireless communication network such as Wi-Fi (registered trademark), Bluetooth (registered trademark), BLE (Bluetooth Low Energy (registered trademark), or LPWA (Low Power Wide Area).

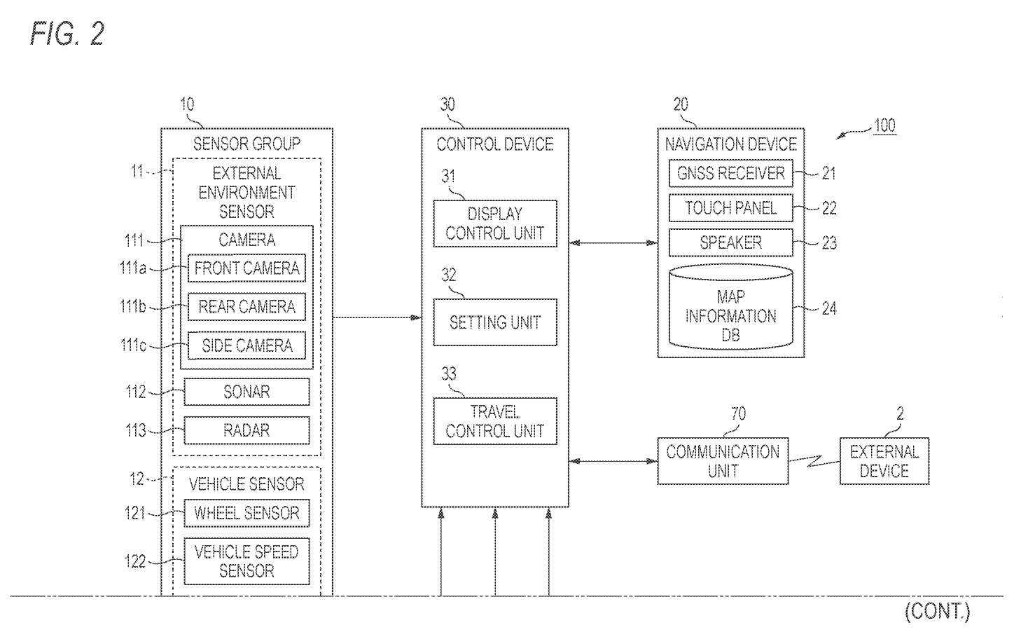

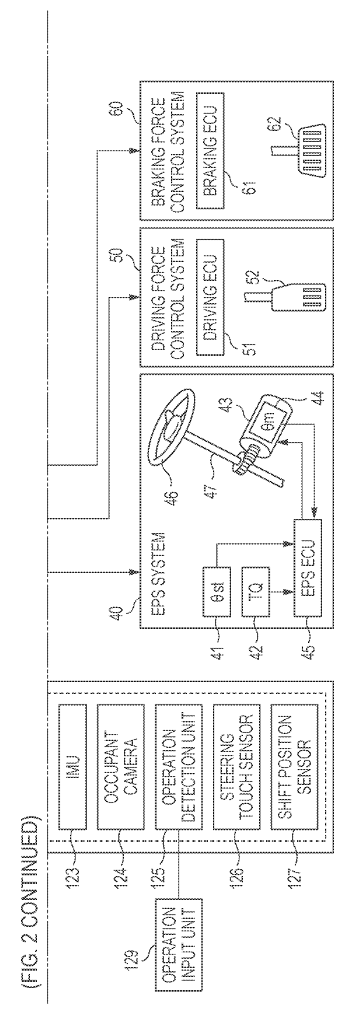

The vehicle 100 is, for example, a four-wheeled automobile capable of autonomously traveling in a parking lot PA provided in a facility FA such as a shopping mall. Here, the autonomous traveling is traveling that does not depend on an operation of a user of the vehicle 100 (hereinafter, also simply referred to as "user", for example, a driver of the vehicle 100). For example, the vehicle 100 autonomously travels to a predetermined target parking position in the parking lot PA to park to a target parking position. A configuration example of the vehicle 100 will be described later with reference to FIG. 2.

The server 200 is a computer that assists autonomous traveling of vehicle 100 in the parking lot PA, and is, for example, a server provided in the facility FA including the parking lot PA, a data center, or the like. Further, the server 200 may be a physical server implemented as one device, and may be a virtual server (so-called cloud server) implemented in a cloud computing service. The server 200 is an example of an information processing device of the present invention.

In general, map information is required for the autonomous traveling of the vehicle 100. However, in general, the parking lot PA is often private land, and it is difficult to store map information of the parking lot PA in the vehicle 100 in advance. Therefore, the server 200 assists autonomous traveling of the vehicle 100 in the parking lot PA by transmitting the map information of the parking lot PA to the vehicle 100 scheduled to enter the parking lot PA or the vehicle 100 entering the parking lot PA.

Specifically, in the present embodiment, the server 200 stores parking lot map information 200a that is the map information of the parking lot PA. The parking lot map information 200a includes, for example, detailed map information DI and simplified map information SI.

The detailed map information DI is an example of first map information used for autonomous traveling of the vehicle 100 to the target parking position in the parking lot PA. The detailed map information DI is map information including detailed information on the parking lot PA to implement the autonomous traveling of the vehicle 100 in the parking lot PA.

For example, the detailed map information DI includes, in addition to information indicating positions of various objects in the parking lot PA and passages for automobiles (hereinafter, also simply referred to as "passages"), information indicating a passage width which is a length of each of the passages in a width direction thereof. Here, examples of the various objects in the parking lot PA include a partition line (for example, a partition line that partitions a parking space, a passage, or the like) in the parking lot PA, a road marking, a sign, a guide plate, a speed bump, a wall, a pillar, an obstacle (for example, an object such as a fallen object that may hinder traveling of an automobile), and the like. The information indicating the positions of the various objects in the detailed map information DI may be feature information indicating these positions as features. For example, the detailed map information DI may include other information such as information indicating attributes (in other words, types) of the various objects.

Meanwhile, the simplified map information SI is an example of second map information representing a simple map of the entire parking lot PA (hereinafter, also referred to as "simplified map"), and is map information having a smaller amount of information (in other words, a smaller data size) than the detailed map information DI. Here, the simplified map is a two-dimensional map that roughly represents an entire image of the parking lot PA and includes, for example, an entrance and an exit of the parking lot PA, each parking space, and each passage.

For example, the server 200 first presents the simplified map to the user by transmitting the simplified map information SI to the vehicle 100 scheduled to enter the parking lot PA or the vehicle 100 entering the parking lot PA, and causes the user to designate a desired target parking position.

Thereafter, the server 200 transmits, to the vehicle 100, the detailed map information DI necessary for autonomous traveling of the vehicle 100 to the target parking position designated by the user. At this time, the server 200 does not transmit the detailed map information DI of the entire parking lot PA to the vehicle 100, but selectively transmits, to the vehicle 100, only the detailed map information DI necessary for the autonomous traveling of the vehicle 100 to the target parking position. Specifically, the server 200 transmits, to the vehicle 100, only the detailed map information DI of a "scheduled travel region" that is a region including a section overlapping the scheduled travel route that is based on the autonomous traveling to the target parking position, in the detailed map information DI of the entire parking lot PA.

Therefore, according to the parking assistance system 1 of the present embodiment, before the vehicle 100 receives, from the server 200, the detailed map information DI that takes time to be received (in other words, downloaded) from the server 200, in other words, without waiting for the download of the detailed map information DI, the user can designate the desired target parking position using the simplified map that is based on the simplified map information SI. Therefore, the target parking position can be quickly designated and convenience for the user can be improved.

Further, according to the parking assistance system 1 of the present embodiment, since only the detailed map information DI necessary for the autonomous traveling to the target parking position in the parking lot PA is selectively transmitted and received between the server 200 and the vehicle 100, an amount of communication between the server 200 and the vehicle 100 can be reduced as compared with a case where the detailed map information DI of the entire parking lot PA is transmitted and received. Accordingly, the vehicle 100 can autonomously travel to the target parking position while reducing a time required for the vehicle 100 to completely receive the detailed map information DI transmitted from the server 200, and the convenience for the user can be improved.

Further, by reducing the amount of communication between the server 200 and the vehicle 100, communication fee in the vehicle 100 can be prevented from increasing due to communication with the server 200 even if the communication fee is based on a metered rate. Further, by reducing the amount of communication between the server 200 and the vehicle 100, even if the communication between the server 200 and the vehicle 100 is performed by wireless communication whose communication speed is less likely to be stable than that of wired communication, the time required for the vehicle 100 to completely receive the detailed map information DI required for the autonomous traveling to the target parking position (that is, a waiting time of the user) can be reduced, and the convenience for the user can be improved.

For example, the server 200 may be configured to acquire, via the communication network NET or the like, image data obtained by a camera CA provided in the parking lot PA or a camera (for example, a camera 111 of the vehicle 100 shown in FIG. 2) provided in the vehicle entering the parking lot PA imaging an inside of the parking lot PA. In this way, the server 200 can grasp a current situation of the parking lot PA (for example, a vacant parking space, a parking space in which the vehicle is parked, or the presence or absence of an obstacle) based on the image data.

Further, the server 200 may be configured to acquire, via the communication network NET or the like, information acquired in the parking lot PA by a sensor (for example, a sensor group 10 of the vehicle 100 shown in FIG. 2) provided in the vehicle entering the parking lot PA. Further, the server 200 may be configured to acquire, via the communication network NET or the like, information indicating a current position of each vehicle entering the parking lot PA.

Hereinafter, the present embodiment will be described in more detail.

### 2. Vehicle

First, a configuration example of the vehicle 100 of the present embodiment will be described with reference to FIG. 2. The vehicle 100 shown in FIG. 2 is an automobile including a drive source (not shown), and wheels (not shown) including drive wheels driven by power of the drive source and steered wheels that are steerable. As an example, the vehicle 100 may be a four-wheeled automobile including a pair of left and right front wheels and a pair of left and right rear wheels.

The drive source of the vehicle 100 may be an electric motor, an internal combustion engine such as a gasoline engine or a diesel engine, or a combination of an electric motor and an internal combustion engine. The drive source of the vehicle 100 may drive the pair of left and right front wheels, the pair of left and right rear wheels, or the four wheels including the pair of left and right front wheels and the pair of left and right rear wheels. The front wheels and the rear wheels of the vehicle 100 may all be steerable steered wheels, or the front wheels or the rear wheels may be steerable steered wheels.

The vehicle 100 includes a sensor group 10, a navigation device 20, a control device 30, an electric power steering (EPS) system 40, a driving force control system 50, a braking force control system 60, and a communication unit 70.

The sensor group 10 includes an external environment sensor 11 that acquires external environment information for recognizing a periphery (in other words, surroundings) of the vehicle 100, and a vehicle sensor 12 that acquires information on the vehicle 100 (hereinafter, also referred to as "vehicle information"). The information acquired by each sensor in the sensor group 10 is output to the control device 30, and is used for control of the vehicle 100 performed by the control device 30.

The external environment sensor 11 includes, for example, cameras 111, a sonar 112, and a radar 113. The cameras 111 image the periphery of the vehicle 100 including the front side of the vehicle 100, and output image data of an obtained peripheral image to the control device 30. Such image data is an example of the external environment information. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on an upper portion of a front windshield or a front grille (not shown) of the vehicle 100, and images a scene in front of the vehicle 100. The rear camera 111b is provided, for example, near a license plate (in other words, an automobile registration number mark) attached to a rear portion of the vehicle 100, and images a scene behind the vehicle 100. The side cameras 111c are provided, for example, on left and right side mirrors (not shown), and image scenes on lateral sides (that is, left and right sides) of the vehicle 100.

The sonar 112 emits sound waves to the periphery of the vehicle 100 (for example, the front side, the rear side, and the lateral sides of the vehicle 100), and receives reflected sounds from an object present in the periphery of the vehicle 100, thereby detecting a distance to the object from the vehicle 100, an azimuth of the object, and the like, and outputs the detection result to the control device 30. The detection result of the sonar 112 is another example of the external environment information.

The radar 113 emits radio waves to the periphery of the vehicle 100 including the front side of the vehicle 100, and receives reflected waves from an object present in the periphery of the vehicle 100, thereby detecting a distance to the object, an azimuth of the object, and the like. As the radar 113, for example, a millimeter wave radar can be adopted. The detection result of the radar 113 is another example of the external environment information.

The external environment sensor 11 may include light detection and ranging (LiDAR) instead of or in addition to the sonar 112 and the radar 113. In this case, the LiDAR emits laser light to the periphery of the vehicle 100 including the front side of the vehicle 100, and receives reflected light from an object present in the periphery of the vehicle 100, thereby detecting a distance to the object from the vehicle 100, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 100. As an example, the wheel sensor 121 detects a rotation angle of each of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 100 (in other words, a movement speed of a vehicle body). For example, the vehicle speed sensor 122 detects the vehicle speed VP based on a rotation speed of a counter shaft (not shown) provided in the vehicle 100.

The inertial measurement unit 123 detects angular velocities of the vehicle 100 in a pitch direction, a roll direction, and a yaw direction, and accelerations of the vehicle 100 in a front-rear direction, a left-right direction, and an upper-lower direction. The vehicle sensor 12 may include, instead of the inertial measurement unit 123, an acceleration sensor that detects an acceleration of the vehicle 100 in a predetermined direction and a gyro sensor that detects an angular velocity of the vehicle 100 in a predetermined direction.

The occupant camera 124 is a digital camera that images an interior of the vehicle 100 and outputs image data of an obtained interior image to the control device 30. For example, the occupant camera 124 can be a so-called "driver monitor camera" provided to be able to image a head of an occupant seated in a driver seat of the vehicle 100 (for example, a user driving the vehicle 100, hereinafter simply referred to as "user") from the front. As the occupant camera 124, a digital camera using an imaging element such as the CCD or the CMOS can be adopted, similarly to the camera 111.

The operation detection unit 125 detects an operation performed by using an operation input unit 129 that is operable by the user, and outputs a detected operation content to the control device 30. The operation input unit 129 may include various user interfaces provided in the vehicle 100.

The steering touch sensor 126 detects whether a steering 46 of the vehicle 100 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not shown) provided in the vehicle 100 is any one of "P (parking)", "R (reverse)", "N (neutral)", and "D (drive)". When the vehicle 100 may take another shift position (for example, "B (brake)") other than the "P", the "R", the "N", and the "D", the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing roads based on a combination of nodes and links connecting the nodes (also referred to as "paths"). Each of the nodes in the road network information represents, for example, a feature of a corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of a corresponding link, a road corresponding to the corresponding link, a link length, a lane number, a travel direction, a road type, and the like is set.

The GNSS receiver 21 specifies a current position of the vehicle 100 (for example, a latitude and a longitude of a location where the vehicle 100 is located) based on a signal received from a GNSS satellite. For example, the navigation device 20 may acquire the detection result of the vehicle sensor 12 (for example, the wheel sensor 121 or the vehicle speed sensor 122) via the control device 30, and specify or complement the current position of the vehicle 100 by an inertial navigation system (INS) using the detection value of the vehicle sensor 12.

For example, the touch panel 22 is implemented by combining a display device such as a liquid crystal display or an organic light emitting diode (OLED) with a sensor device (for example, a touch pad) for detecting an operation of the user. The touch panel 22 functions as a display unit capable of displaying an image such as a map, and an operation reception unit capable of receiving an operation of the user. The speaker 23 is configured to output a sound to the occupant of the vehicle 100 including the user.

For example, the navigation device 20 searches for, by referring to the map information database 24, a route from the current position of the vehicle 100 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 outputs predetermined information (for example, information indicating an operation received from the user via the touch panel 22) to the control device 30.

The control device 30 is a computer that generally controls the entire vehicle 100. For example, the control device 30 may be implemented by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 100, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 100. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, the driving ECU 51 controls power output from the drive source of the vehicle 100, based on an operation on an accelerator pedal 52 provided in the vehicle 100. The driving ECU 51 can also control the driving force control system 50 (for example, the drive source) according to an instruction from the control device 30.

The braking force control system 60 includes a braking ECU 61, and is configured to control a braking force of the vehicle 100. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 100 by controlling a brake device (not shown) provided in the vehicle 100, based on an operation on a brake pedal 62 provided in the vehicle 100. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under control performed by the control device 30. That is, the control device 30 may communicate with the external device 2 via the communication unit 70. Examples of the external device 2 include the server 200 described above and a terminal device (for example, a smartphone) of the user. As described above, a mobile communication network, WI-FI, Bluetooth, BLE, LPWA, or the like can be used for the communication between the vehicle 100 and the external device 2. The communication unit 70 may function as a reception unit that receives information (for example, the detailed map information DI and the simplified map information SI) transmitted from the server 200 to the vehicle 100.

### 3. Control Device

The control device 30 includes a processor (not shown) that performs various calculations, a storage unit (not shown) including a non-transitory storage medium that stores various types of information (for example, programs and various types of data), and an input and output unit (not shown) as an interface that controls input and output of data between the inside and the outside of the control device 30. The control device 30 includes, for example, a display control unit 31, a setting unit 32, and a travel control unit 33 as functional units implemented by the processor executing the programs stored in the storage unit.

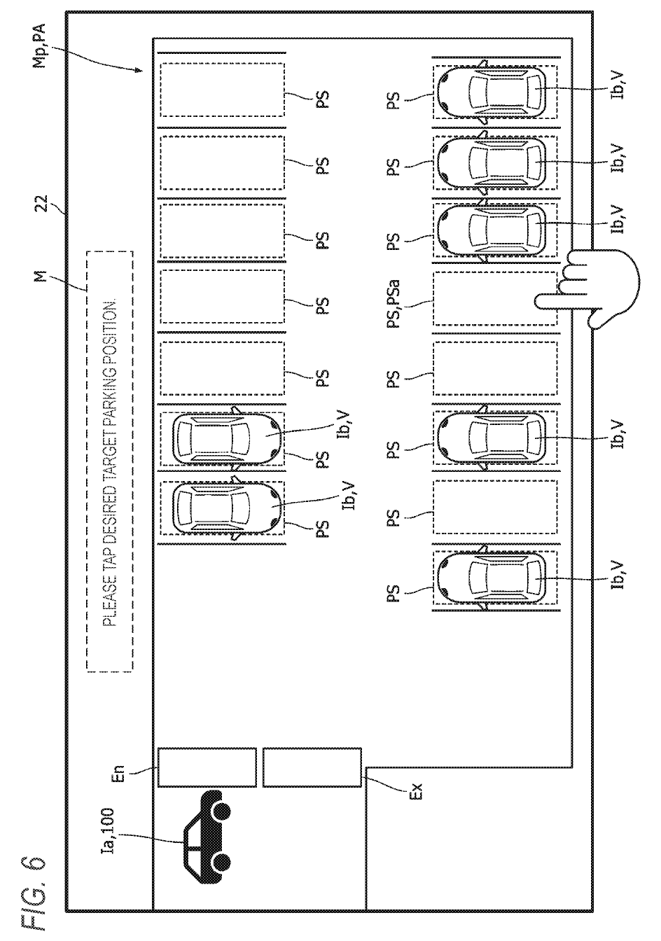

The display control unit 31 has a function of displaying a predetermined image on a predetermined display device provided in the vehicle 100. For example, when the vehicle 100 (for example, the communication unit 70) receives the simplified map information SI from the server 200, the display control unit 31 displays a simplified map Mp, which is a simple map of the parking lot PA based on the simplified map information SI, on the touch panel 22. A display example of the simplified map Mp will be described later with reference to FIG. 6 and the like.

The setting unit 32 has a function of setting a target parking position Ptag of the vehicle 100 in the parking lot PA based on an operation received from the user. For example, the setting unit 32 sets the target parking position Ptag based on an operation received via the simplified map Mp displayed on the touch panel 22. A setting example of the target parking position Ptag will be described later with reference to FIG. 6 and the like.

The travel control unit 33 has a function of controlling the travel of the vehicle 100. For example, when the vehicle 100 (for example, the communication unit 70) receives the detailed map information DI of the scheduled travel region from the server 200, the travel control unit 33 uses the detailed map information DI of the scheduled travel region and the information acquired by the sensor group 10 (for example, the external environment information acquired by the external environment sensor 11) to autonomously travel to the target parking position Ptag.

### 4. Server

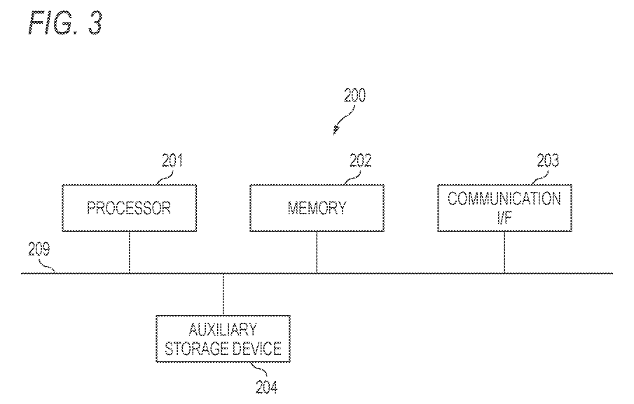

Next, a configuration example of the server 200 of the present embodiment will be described with reference to FIG. 3. As shown in FIG. 3, the server 200 includes a processor 201, a memory 202, a communication interface (I/F) 203, and an auxiliary storage device 204. These components of the server 200 are connected to one another by a bus 209.

The processor 201 is an example of the control unit in the server 200 (that is, the information processing device), and controls the entire server 200. The processor 201 is implemented by, for example, a central processing unit (CPU), a micro controller unit (MCU), or a micro processor unit (MPU). The processor 201 may include a plurality of cores.

The memory 202 is, for example, a storage unit including a non-transitory storage medium such as a read only memory (ROM), a random access memory (RAM), or a flash ROM. For example, the flash ROM and the ROM store various programs, and the RAM is used as a work area of the processor 201. The programs stored in the memory 202 are loaded into the processor 201 to cause the processor 201 to execute coded processing. The programs stored in the memory 202 may include the program of the present invention.

The auxiliary storage device 204 is a storage unit that stores the parking lot map information 200a, and is implemented by, for example, a non-volatile and large-capacity storage device such as a hard disk drive (HDD) or a solid state drive (SSD). FIG. 3 shows an example in which the auxiliary storage device 204 is provided in the server 200, but the present invention is not limited thereto. For example, the auxiliary storage device 204 may be provided outside the server 200 in a state of being accessible by the server 200.

### 5. Operation Example of Parking Assistance System

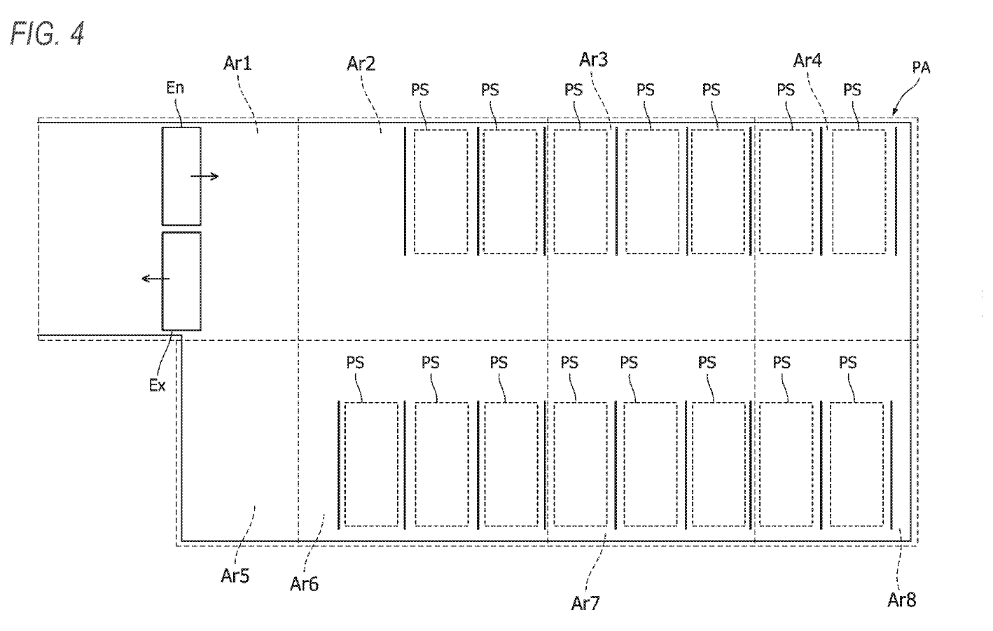

Next, an operation example of the parking assistance system 1 will be described. First, an example of the parking lot PA in the following description will be described with reference to FIG. 4.

### Example of Parking Lot

As shown in FIG. 4, the parking lot PA is divided into a total of eight regions from a first region Ar1 to an eighth region Ar8. A boundary line of each region is, for example, virtual, and can be freely determined by an administrator of the server 200 or the like. That is, these regions may be formed by dividing the parking lot PA according to a predetermined condition determined by the administrator of the server 200 or the like. As an example, these regions may be formed by dividing the parking lot PA by a predetermined distance or a predetermined area. As another example, these regions may be formed by dividing the parking lot PA such that a data sizes of the detailed map information DI of each of these regions are equal to each other.

Further, the detailed map information DI of each region may be obtained by dividing the detailed map information DI of the entire parking lot PA every predetermined data size, or may be obtained by dividing in consideration of a transmission time (in other words, a required time during transmission). When the detailed map information DI of the entire parking lot PA is divided according to the transmission time, a reference transmission time can be, for example, a time at which the user does not feel stress during the reception. Further, how to divide the detailed map information DI of the entire parking lot PA may be variable depending on a communication situation between the server 200 and the vehicle 100. For example, when the communication situation between the server 200 and the vehicle 100 is good, each region may be formed by dividing the parking lot PA every 100 [m²], and when the communication situation is bad, each region may be formed by dividing the parking lot PA every 50 [m²].

In the parking lot PA, for example, an entrance En, an exit Ex, and a plurality of parking spaces PS are provided. Here, the entrance En is a region through which an automobile such as the vehicle 100 passes when entering the parking lot PA. The exit Ex is a region through which an automobile such as the vehicle 100 passes when exiting from the parking lot PA. The parking spaces PS are regions where an automobile such as the vehicle 100 can be parked. In the parking lot PA, a region excluding the entrance En, the exit Ex, and each parking space PS is, for example, a region where an automobile such as the vehicle 100 can travel (hereinafter, also referred to as "travel-possible region"), and may constitute the above-described passage (that is, a passage for the automobile).

The auxiliary storage device 204 shown in FIG. 3 stores the detailed map information DI for each of the first region Ar1 to the eighth region Ar8. In other words, the detailed map information DI of the entire parking lot PA includes the detailed map information DI of each of the first region Ar1 to the eighth region Ar8. For example, the detailed map information DI of the first region Ar1 includes information indicating positions of various objects present in the first region Ar1, a passage in the first region Ar1, a passage width of the passage, or the like. Similarly, the detailed map information DI of each of the regions other than the first region Ar1 also includes information indicating positions of various objects present in the region, a passage in the region, a passage width of the passage, or the like.

### Operation Example of Parking Assistance System

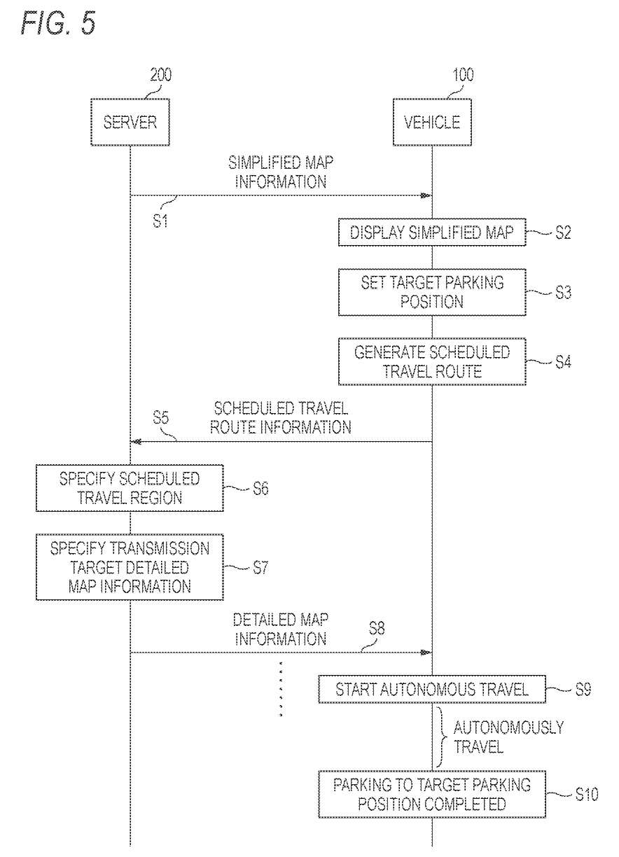

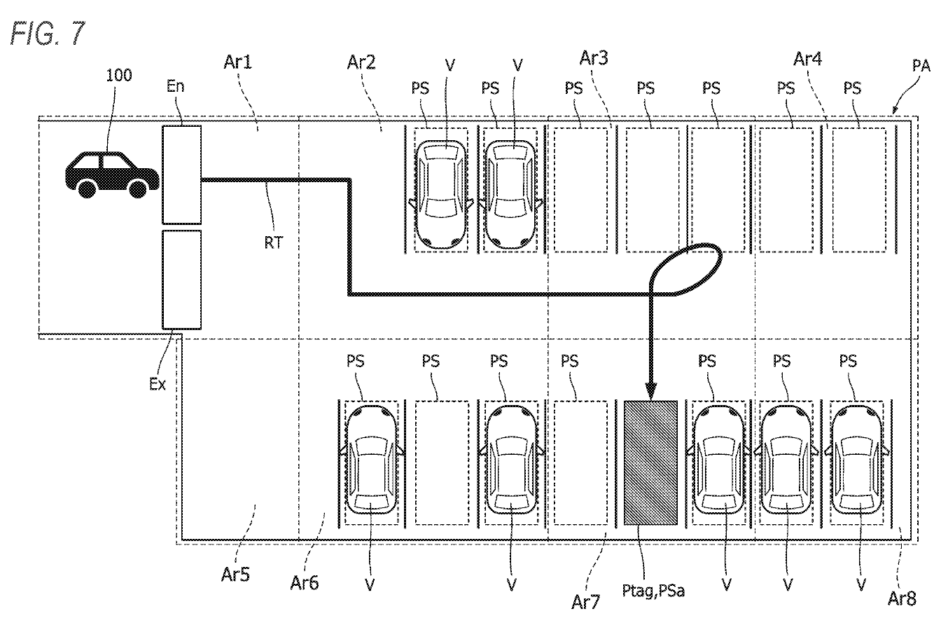

Next, according to a sequence diagram shown in FIG. 5, an operation example of the parking assistance system 1 will be described with reference to FIGS. 6 and 7.

As shown in FIG. 5, the server 200 transmits the simplified map information SI of the parking lot PA to the vehicle 100 scheduled to enter the parking lot PA (step S1). For example, when detecting the vehicle 100 that arrives at the entrance En of the parking lot PA based on the image data or the like from the camera CA (see FIG. 1) provided in the parking lot PA, the server 200 transmits the simplified map information SI to the vehicle 100. Accordingly, the communication unit 70 of the vehicle 100 can receive the simplified map information SI from the server 200 when the vehicle 100 reaches the parking lot PA.

Instead of the above, for example, when a distance from the vehicle 100 to the parking lot PA (for example, the entrance En) is equal to or less than a threshold (for example, 100 [m]), that is, when the vehicle 100 approaches the parking lot PA, the server 200 may transmit the simplified map information SI to the vehicle 100. In this way, the communication unit 70 of the vehicle 100 can receive the simplified map information SI from the server 200 before the vehicle 100 reaches the parking lot PA.

Next, the vehicle 100 (for example, the control device 30) displays the simplified map Mp shown in FIG. 6 on the touch panel 22 based on the simplified map information SI received from the server 200 (step S2). As described above, the simplified map Mp is, for example, a two-dimensional map roughly representing an entire image of the parking lot PA.

As shown in FIG. 6, the vehicle 100 may display an own vehicle icon Ia corresponding to the vehicle 100 at a position on the simplified map Mp corresponding to a current position of the vehicle 100. Further, the vehicle 100 may display an other-vehicle icon Ib in the parking space PS in which another vehicle V different from the vehicle 100 is parked among the parking spaces PS on the simplified map Mp.

Further, in order to receive a designation for the target parking position Ptag from the user via the displayed simplified map Mp, the vehicle 100 may display a message M prompting the designation for the target parking position Ptag together with the simplified map Mp. In the example shown in FIG. 6, a message such as "Please tap a desired target parking position." is displayed as a message M.

Next, the vehicle 100 sets the target parking position Ptag based on the operation received from the user via the displayed simplified map Mp (step S3). For example, the user can designate a vacant parking space PS as the target parking position Ptag by tapping the parking space PS on the simplified map Mp displayed on the touch panel 22. In the example shown in FIG. 6, a position corresponding to a parking space PSa is tapped on the simplified map Mp. In this case, as shown in FIG. 7, the vehicle 100 sets the parking space PSa as the target parking position Ptag.

Next, the vehicle 100 generates a scheduled travel route RT of the vehicle 100 in the parking lot PA to the set target parking position Ptag (step S4). For example, as shown in FIG. 7, based on the simplified map information SI received from the server 200 and the target parking position Ptag, the vehicle 100 searches for a route from the entrance En to the target parking position Ptag along which the vehicle 100 is to be parked to the target parking position Ptag, and generates the found route as the scheduled travel route RT. Then, the vehicle 100 transmits scheduled travel route information indicating the generated scheduled travel route RT to the server 200 (step S5). The scheduled travel route information may include, for example, information indicating each point (in other words, each node) in the parking lot PA overlapping the scheduled travel route RT and a passing order of the points when the vehicle 100 travels on the scheduled travel route RT.

Next, the server 200 specifies a scheduled travel region including a section overlapping the scheduled travel route RT, based on the scheduled travel route information received from the vehicle 100 (step S6). In the example shown in FIG. 7, among the first region Ar1 to the eighth region Ar8, the first region Ar1, the second region Ar2, the third region Ar3, and the seventh region Ar7 are regions including a section overlapping the scheduled travel route RT, that is, scheduled travel regions. Therefore, in this case, in the processing in step S6, the first region Ar1, the second region Ar2, the third region Ar3, and the seventh region Ar7 are specified as the scheduled travel regions.

Next, the server 200 specifies the detailed map information DI for the specified scheduled travel regions as transmission target detailed map information (step S7). For example, it is assumed that the first region Ar1, the second region Ar2, the third region Ar3, and the seventh region Ar7 are specified as the scheduled travel regions. In this case, in the processing in step S7, the detailed map information DI corresponding to each of the first region Ar1, the second region Ar2, the third region Ar3, and the seventh region Ar7 is specified as the transmission target detailed map information.

Then, the server 200 transmits the detailed map information DI specified as the transmission target detailed map information to the vehicle 100 (step S8). At this time, the server 200 preferably performs the transmission to the vehicle 100 in order from the detailed map information DI of a region where the vehicle 100 reaches earlier in time series. In the example shown in FIG. 7, when being arranged in order from the region where the vehicle 100 reaches earlier in time series, the regions are the first region Ar1, the second region Ar2, the third region Ar3, and the seventh region Ar7. Therefore, in this case, the server 200 preferably transmits the detailed map information DI corresponding to each region to the vehicle 100 in order of the first region Ar1, the second region Ar2, the third region Ar3, and the seventh region Ar7.

Then, when receiving detailed map information DI from the server 200, the vehicle 100 starts to autonomously travel in parking lot PA (step S9). At this time, the vehicle 100 autonomously travels in the parking lot PA along the scheduled travel route RT using the detailed map information DI received from the server 200. For example, when traveling in a section included in the first region Ar1, the vehicle 100 autonomously travels in the first region Ar1 along the scheduled travel route RT using the detailed map information DI of the first region Ar1 received from the server 200. When traveling in a section included in the second region Ar2, the vehicle 100 autonomously travels in the second region Ar2 along the scheduled travel route RT using the detailed map information DI of the second region Ar2 received from the server 200. Therefore, by performing the transmission to the vehicle 100 in order from the detailed map information DI of the region where the vehicle 100 reaches earlier in time series, the vehicle 100 can autonomously travel to the target parking position Ptag efficiently by sequentially using the received detailed map information DI.

Then, when the vehicle 100 autonomously traveling in the parking lot PA reaches the target parking position Ptag, parking of the vehicle 100 to the target parking position Ptag is completed (step S10).

As described above, the server 200 of the present embodiment first transmits the simplified map information SI representing the simple map of the entire parking lot PA to the vehicle 100. Then, the target parking position Ptag is set by the user of the vehicle 100 using the simplified map information SI. Therefore, according to the present embodiment, the user of the vehicle 100 can set the desired target parking position Ptag without transmitting the detailed map information DI of the parking lot PA to the vehicle 100.

Further, the server 200 acquires the scheduled travel route information indicating the scheduled travel route RT for the autonomous travel to the target parking position Ptag, and transmits, to the vehicle 100, the detailed map information DI of the scheduled travel region including a section overlapping the scheduled travel route RT. Accordingly, since the detailed map information DI necessary for the vehicle 100 to autonomously travel to the target parking position Ptag in the parking lot PA can be selectively transmitted to the vehicle 100, an amount of communication between the server 200 and the vehicle 100 can be reduced while allowing the vehicle 100 to autonomously travel to the target parking position Ptag.

In other words, the vehicle 100 of the present embodiment may receive, from the server 200, the detailed map information DI of the scheduled travel region including the section overlapping the scheduled travel route RT, that is, the detailed map information DI necessary for the vehicle 100 to autonomously travel to the target parking position Ptag in the parking lot PA. Then, when receiving the detailed map information DI of the scheduled travel region, the vehicle 100 autonomously travels to the target parking position Ptag using the detailed map information DI of the scheduled travel region. Accordingly, the amount of communication between the server 200 and the vehicle 100 can be reduced while enabling the vehicle 100 to autonomously travel to the target parking position Ptag.

### 6. Transmission and Reception of Detailed Map Information Between Server and Vehicle

Next, examples of transmission and reception of the detailed map information DI between the server 200 and the vehicle 100 will be described more specifically. In the following description of each example of the transmission and reception, as shown in FIG. 7, it is assumed that the first region Ar1, the second region Ar2, the third region Ar3, and the seventh region Ar7 are specified as the scheduled travel regions.

### First Example of Transmission and Reception of Detailed Map Information

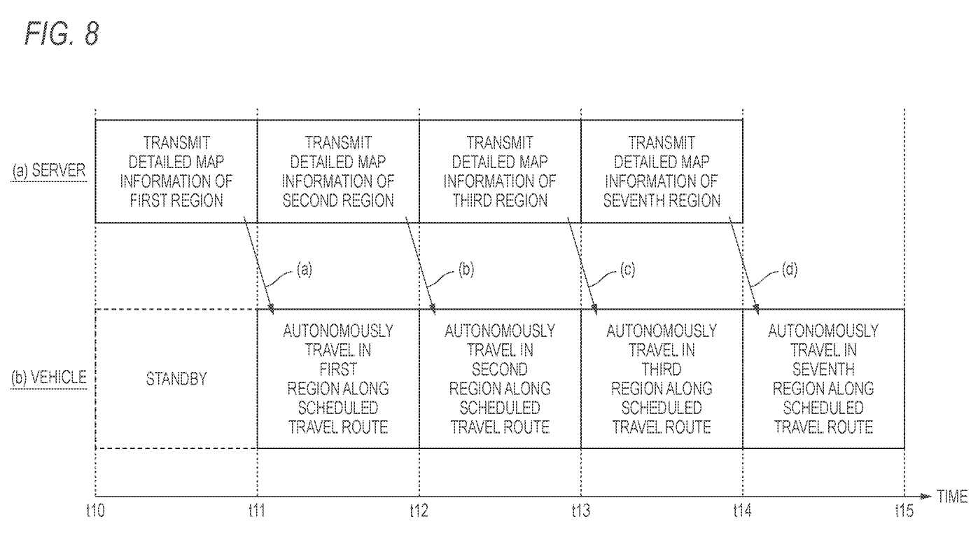

First, a first example of the transmission and reception of the detailed map information DI between the server 200 and the vehicle 100 will be described with reference to FIG. 8. In the first example shown in FIG. 8, the server 200 first starts to transmit the detailed map information DI of the first region Ar1 from a time t10 when the transmission target detailed map information is specified based on the scheduled travel route RT of the vehicle 100. The transmission of the detailed map information DI of the first region Ar1 is completed at a time t11 after the time t10. In other words, at the time t11, the reception of the detailed map information DI of the first region Ar1 is completed in the vehicle 100.

In this case, the vehicle 100 stands by until the time t11 and starts to autonomously travel in the first region Ar1 from the time t11. Then, the vehicle 100 autonomously travels in the first region Ar1 along the scheduled travel route RT using the detailed map information DI of the first region Ar1 received from the server 200 (see (a) in FIG. 8).

Further, from the time t11, the server 200 starts to transmit the detailed map information DI of the second region Ar2 to be reached by the vehicle 100 next to the first region Ar1. The transmission of the detailed map information DI of the second region Ar2 is completed at a time t12 after the time t11. In other words, at the time t12, the reception of the detailed map information DI of the second region Ar2 is completed in the vehicle 100. In the example shown in FIG. 8, the autonomous travel of the vehicle 100 in the first region Ar1 is also completed at the time t12.

In this case, the vehicle 100 starts to autonomously travel in the second region Ar2 from the time t12. Then, the vehicle 100 autonomously travels in the second region Ar2 along the scheduled travel route RT using the detailed map information DI of the second region Ar2 received from the server 200 (see (b) in FIG. 8).

Further, the server 200 starts to transmit the detailed map information DI of the third region Ar3 to be reached by the vehicle 100 next to the second region Ar2, from the time t12. The transmission of the detailed map information DI of the third region Ar3 is completed at a time t13 after the time t12. In other words, at the time t13, the reception of the detailed map information DI of the third region Ar3 is completed in the vehicle 100. In the example shown in FIG. 8, the autonomous travel of the vehicle 100 in the second region Ar2 is also completed at the time t13.

In this case, the vehicle 100 starts to autonomously travel in the third region Ar3 from the time t13. Then, the vehicle 100 autonomously travels in the third region Ar3 along the scheduled travel route RT using the detailed map information DI of the third region Ar3 received from the server 200 (see (c) in FIG. 8).

Further, the server 200 starts to transmit the detailed map information DI of the seventh region Ar7 to be reached by the vehicle 100 next to the third region Ar3 from the time t13. The transmission of the detailed map information DI of the seventh region Ar7 is completed at a time t14 after the time t13. In other words, at the time t14, the reception of the detailed map information DI of the seventh region Ar7 is completed in the vehicle 100. In the example shown in FIG. 8, the autonomous travel of the vehicle 100 in the third region Ar3 is also completed at the time t14.

In this case, the vehicle 100 starts to autonomously travel in the seventh region Ar7 from the time t14. Then, the vehicle 100 autonomously travels in the seventh region Ar7 along the scheduled travel route RT using the detailed map information DI of the seventh region Ar7 received from the server 200 (see (d) in FIG. 8), and parking of the vehicle 100 to the target parking position Ptag in the seventh region Ar7 is completed at a time t15 after the time t14.

As described above, when the scheduled travel region includes two or more regions, the server 200 (for example, the processor 201) may perform the transmission to the vehicle 100 in order from the detailed map information DI of the region where the vehicle 100 reaches earlier in time series among the two or more regions. In this way, since the transmission can be performed in order from the detailed map information DI that is needed earlier for the vehicle 100 to autonomously travel to the target parking position Ptag, the vehicle 100 can autonomously travel to the target parking position Ptag efficiently by sequentially using the received detailed map information DI.

In other words, when the scheduled travel region includes two or more regions, the vehicle 100 (for example, the communication unit 70) may perform the reception from the server 200 in order from the detailed map information DI of the region where the vehicle 100 reaches earlier in time series among the two or more regions. In this way, since the reception can be performed in order from the detailed map information DI that is needed earlier for the vehicle 100 to autonomously travel to the target parking position Ptag, the autonomously travel to the target parking position Ptag can be efficiently performed by sequentially using the received detailed map information DI.

Further, before the vehicle 100 reaches one region included in the scheduled travel regions, the server 200 may transmit the detailed map information DI of the one region to the vehicle 100. In this way, before the vehicle 100 reaches one region included in the scheduled travel regions, the detailed map information DI of the one region can be transmitted to the vehicle 100, and thus, after reaching the one region, the vehicle 100 can autonomously travel quickly using the detailed map information DI of the one region.

In other words, before the vehicle 100 reaches one region included in the scheduled travel regions, the vehicle 100 may receive the detailed map information DI of the one region from the server 200. In this way, before the vehicle 100 reaches one region included in the scheduled travel regions, the detailed map information DI of the one region can be received from the server 200, and thus, after reaching the one region, the vehicle 100 can autonomously travel quickly using the detailed map information DI of the one region.

### Second Example of Transmission and Reception of Detailed Map Information

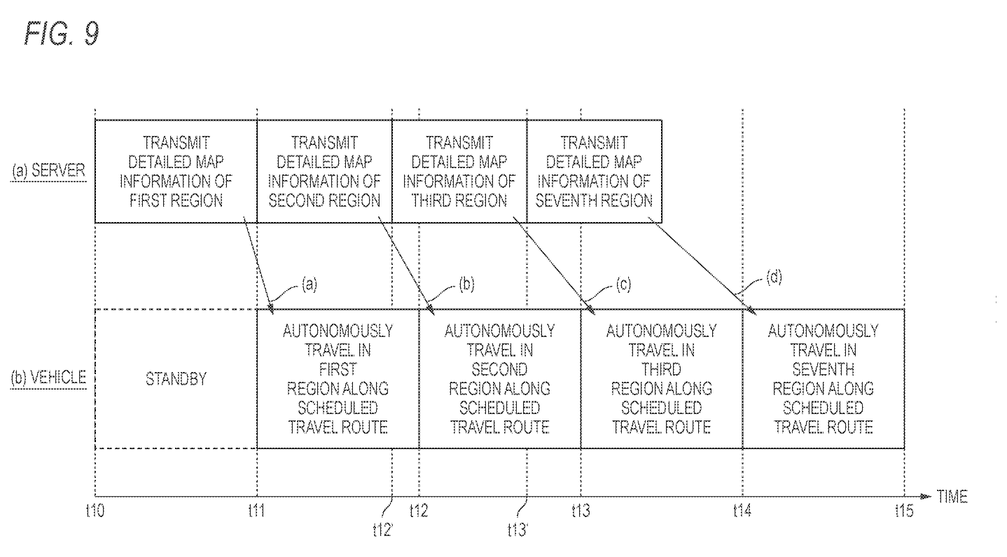

Next, a second example of the transmission and reception of the detailed map information DI between the server 200 and the vehicle 100 will be described with reference to FIG. 9. In the following, portions different from the first example shown in FIG. 8 will be mainly described, and the description of portions common to the first example shown in FIG. 8 will be appropriately omitted or simplified.

The second example shown in FIG. 9 is different from the first example shown in FIG. 8 in that, for example, the transmission of the detailed map information DI of the second region Ar2 is completed at a time t12′ before the time t12 at which the autonomous travel of the vehicle 100 in the first region Ar1 is completed. In this case, the server 200 may start to transmit the detailed map information DI of the third region Ar3 to the vehicle 100 from the time t12′ in the middle of the autonomous travel of the vehicle 100 in the first region Ar1.

The second example shown in FIG. 9 is also different from the first example shown in FIG. 8 in that the transmission of the detailed map information DI of the third region Ar3 to the vehicle 100 is completed at a time t13′ before the time t13 at which the autonomous travel of the vehicle 100 in the second region Ar2 is completed. Similarly to the above, in this case, the server 200 may start to transmit the detailed map information DI of the seventh region Ar7 to the vehicle 100 from the time t13′ in the middle of the autonomous travel of the vehicle 100 in the second region Ar2.

### Third Example of Transmission and Reception of Detailed Map Information

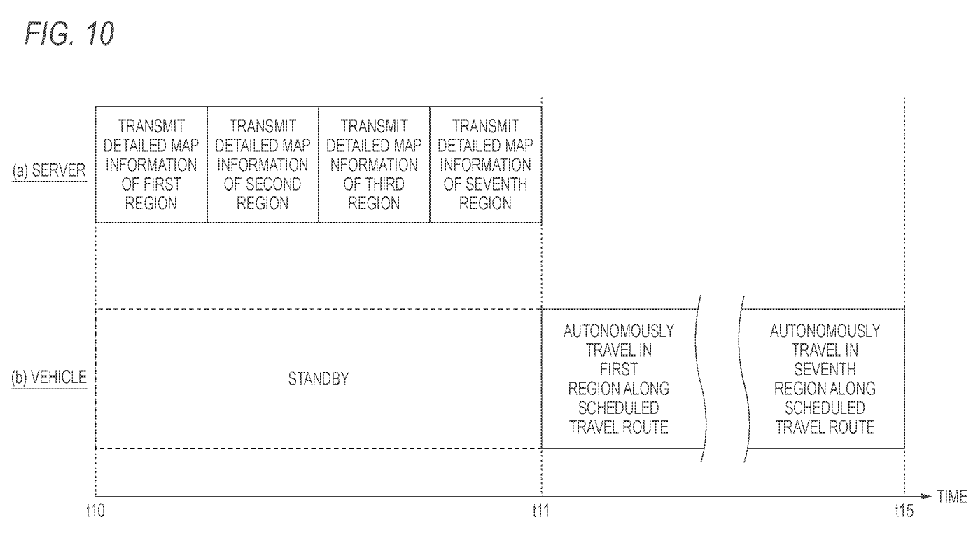

Next, a third example of the transmission and reception of the detailed map information DI between the server 200 and the vehicle 100 will be described with reference to FIG. 10. In the following, portions different from the first example shown in FIG. 8 will be mainly described, and the description of portions common to the first example shown in FIG. 8 will be appropriately omitted or simplified.

The third example shown in FIG. 10 is effective when a total amount of the detailed map information DI of each region (that is, each region included in the scheduled travel regions) necessary for the vehicle 100 to autonomously travel to the target parking position Ptag is relatively small.

For example, in the third example, as shown in FIG. 10, a total amount of the detailed map information DI of the first region Ar1, the second region Ar2, the third region Ar3, and the seventh region Ar7 is small enough to be transmitted from the server 200 to the vehicle 100 within a certain period (in the example shown in FIG. 10, a period from the time t10 to the time t11).

In such a case, the server 200 may transmit the detailed map information DI of each of the first region Ar1, the second region Ar2, the third region Ar3, and the seventh region Ar7 to the vehicle 100 in the period from the time t10 to the time t11. In this way, the vehicle 100 can receive, from the server 200, the detailed map information DI of the entire region necessary for the autonomous travel to the target parking position Ptag during the period from the time t10 to the time t11 during standby. Therefore, thereafter, the vehicle 100 can autonomously travel to the target parking position Ptag by sequentially using the received detailed map information DI of each region.

### 7. Modification

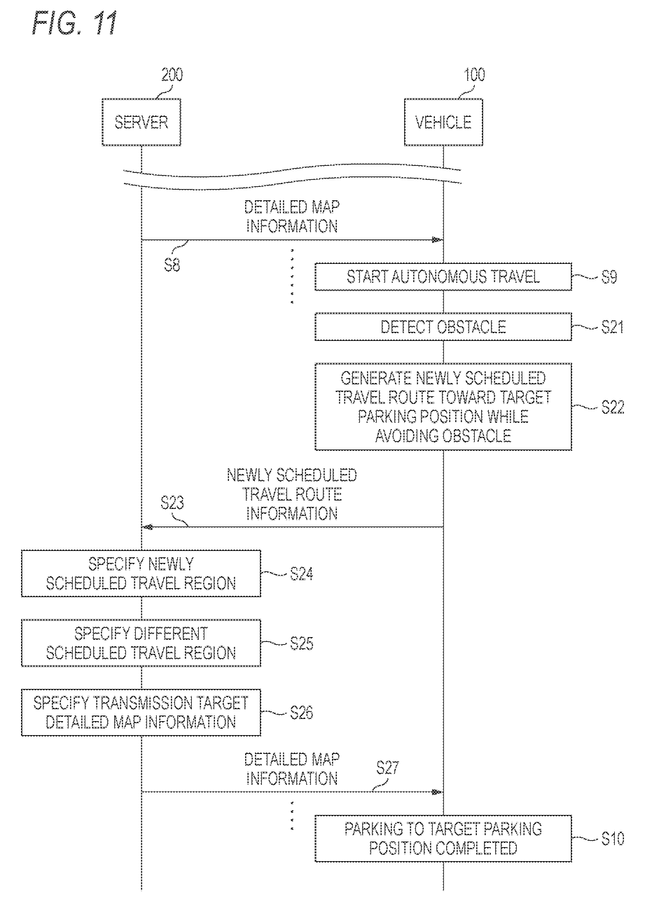

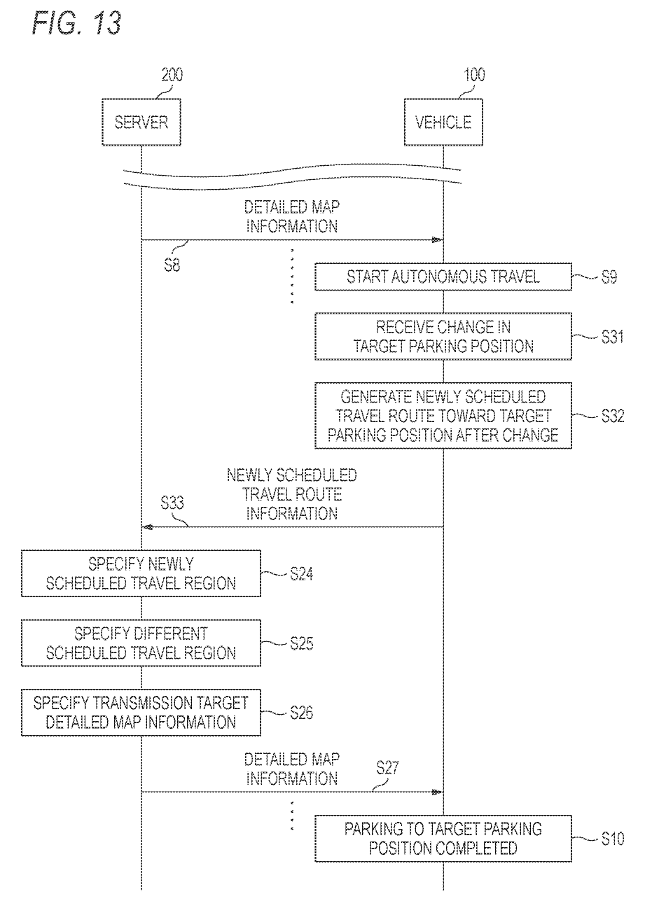

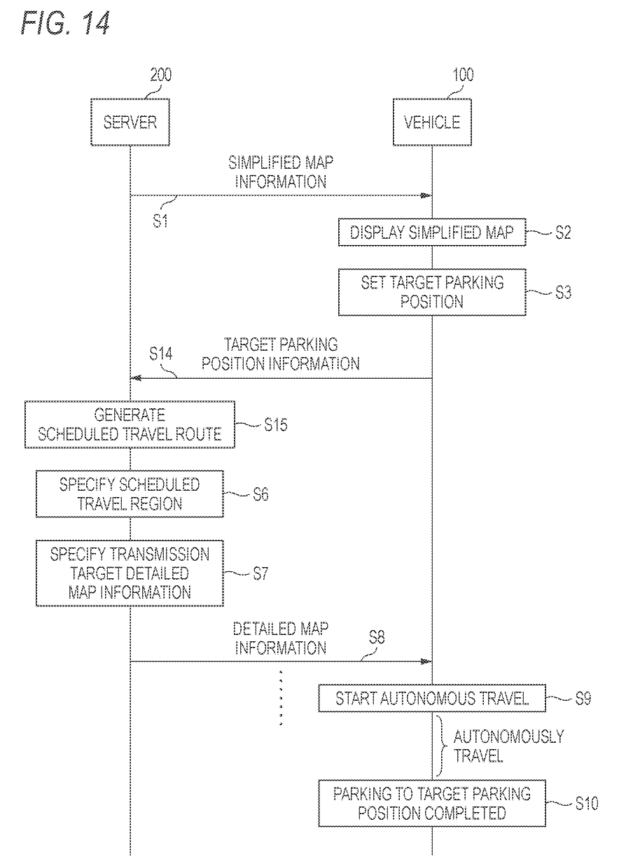

Next, a modification of the above-described embodiment will be described with reference to FIGS. 11 and 14. In the following, portions different from the example described above will be mainly described, and the description of portions common to the example described above will be appropriately omitted or simplified. Further, in FIGS. 11 and 13, since a portion before step S8 is similar to the example shown in FIG. 5, the illustration thereof is omitted.

### First Modification

A first modification is an example of a case where an obstacle Ob is detected in the process of the vehicle 100 autonomously traveling along the scheduled travel route RT, and a newly scheduled travel route RTnew toward the target parking position Ptag while avoiding the obstacle Ob is generated. Here, the obstacle Ob is an example of a target present in a periphery of the scheduled travel route RT.

As shown in FIG. 11, in the first modification, after the processing in step S9, when detecting the obstacle Ob in the process of the autonomous travel along the scheduled travel route RT (step S21), the vehicle 100 generates the newly scheduled travel route RTnew toward the target parking position Ptag while avoiding the obstacle Ob (step S22).

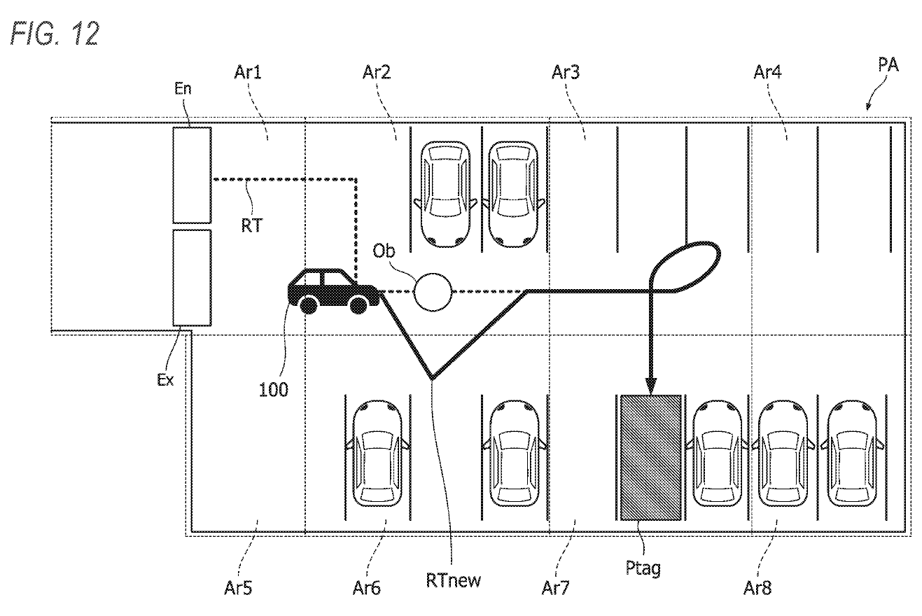

For example, as shown in FIG. 12, it is assumed that the obstacle Ob is present in the second region Ar2 included in the scheduled travel regions. In this case, the vehicle 100 detects the obstacle Ob during the autonomous travel in the second region Ar2, and to avoid the obstacle Ob, the vehicle 100 deviates from the second region Ar2 to the sixth region Ar6, and then generates the newly scheduled travel route RTnew toward the target parking position Ptag on the same route as the original scheduled travel route RT.

After generating the newly scheduled travel route RTnew in this way, the vehicle 100 transmits newly scheduled travel route information indicating the newly scheduled travel route RTnew to the server 200 (step S23).

When receiving the newly scheduled travel route information from the vehicle 100, the server 200 specifies a newly scheduled travel region including a section overlapping the newly scheduled travel route RTnew based on the received newly scheduled travel route information (step S24). In the example shown in FIG. 12, the second region Ar2, the sixth region Ar6, the third region Ar3, and the seventh region Ar7 are specified as the newly scheduled travel regions.

Next, the server 200 specifies a different scheduled travel region (step S25). The different scheduled travel region is a region that is not included in the original scheduled travel route RT but is included in the newly scheduled travel route RTnew. In the case of the example shown in FIG. 12, the sixth region Ar6 is specified as the different scheduled travel region.

Next, the server 200 specifies untransmitted detailed map information DI to which the detailed map information DI of the different scheduled travel region is added as the transmission target detailed map information (step S26). In the case shown in FIG. 12, if the transmission of the detailed map information DI of the third region Ar3 is completed before the scheduled travel route RT is changed, the untransmitted detailed map information DI is the detailed map information DI of the sixth region Ar6 and the seventh region Ar7. If the transmission of the detailed map information DI of the seventh region Ar7 is completed before the scheduled travel route RT is changed, the untransmitted detailed map information DI is only the detailed map information DI of the sixth region Ar6.

Thereafter, the server 200 transmits the untransmitted detailed map information DI to the vehicle 100 (step S27). Then, the vehicle 100 autonomously travels in each region using the detailed map information DI of the corresponding region received from the server 200, thereby completing the parking to the target parking position Ptag (step S10).

In this way, according to the first modification, even when the scheduled travel route RT is changed for a reason of avoiding the obstacle Ob or the like, the server 200 can selectively transmit, to the vehicle 100, only the detailed map information DI necessary for the vehicle 100 to autonomously travel to the target parking position Ptag.

In other words, even when the scheduled travel route RT is changed for the reason of avoiding the obstacle Ob or the like, the vehicle 100 can receive, from the server 200, only the detailed map information DI necessary for the vehicle 100 to autonomously travel to the target parking position Ptag.

### Second Modification

A second modification is an example of a case where, since the user performs an operation of changing the target parking position Ptag after the vehicle 100 starts to autonomously travel along the scheduled travel route RT, a newly scheduled travel route toward the target parking position Ptag after change is generated.

As shown in FIG. 13, in the second modification, after the processing in step S9, when receiving a change in the target parking position Ptag in the process of the autonomous travel along the scheduled travel route RT (step S31), the vehicle 100 generates the newly scheduled travel route toward the changed target parking position Ptag (step S32), and transmits the newly scheduled travel route information indicating the generated newly scheduled travel route to the server 200 (step S33). In this case, as in the example shown in FIG. 11, the server 200 may specify the newly scheduled travel region, the different scheduled travel region, and the transmission target detailed map information, and transmit the untransmitted detailed map information DI to the vehicle 100.

In this way, according to the second modification, even when the scheduled travel route RT is changed due to the change in the target parking position Ptag, the server 200 can selectively transmit, to the vehicle 100, only the detailed map information DI necessary for the vehicle 100 to autonomously travel to the target parking position Ptag.

In other words, even when the scheduled travel route RT is changed due to the change in the target parking position Ptag, the vehicle 100 can receive, from the server 200, only the detailed map information DI necessary for the vehicle 100 to autonomously travel to the target parking position Ptag.

### Third Modification

A third modification is an example of a case where the server 200 generates the scheduled travel route RT.

As shown in FIG. 14, in the third modification, when the target parking position Ptag is set, the vehicle 100 transmits target parking position information indicating the set target parking position Ptag to the server 200 (step S14). In this case, the server 200 may generate the scheduled travel route RT, for example, based on the simplified map information SI and the target parking position information received from the vehicle 100, as in the processing in step S4 shown in FIG. 5 (step S15). Thereafter, as in the example shown in FIG. 5, the server 200 may specify the scheduled travel region and the transmission target detailed map information and transmit the detailed map information DI specified as the transmission target detailed map information to the vehicle 100.

In this way, according to the third modification, based on the scheduled travel route RT generated by the server 200 itself, the server 200 can selectively transmit, to the vehicle 100, only the detailed map information DI necessary for the vehicle 100 to autonomously travel to the target parking position Ptag. Further, since the vehicle 100 does not need to perform the processing of generating the scheduled travel route RT, a processing load of the control device 30 can be reduced accordingly.

The first modification or the second modification can be combined with the third modification. For example, when the second modification and the third modification are combined, the vehicle 100 may transmit the target parking position information indicating the target parking position Ptag after change to the server 200, and the server 200 may generate the newly scheduled travel route.

As described above, according to the present embodiment and the modifications thereof, it is possible to improve the convenience for the user in the vehicle 100 that autonomously travels in the parking lot PA using the detailed map information DI of the parking lot PA received from the server 200. Further, it is possible to reduce the amount of communication between the server 200 and the vehicle 100 that autonomously travels in the parking lot PA using the map information of the parking lot PA received from the server 200. This can further improve safety of traffic and contribute to development of a sustainable transportation system.

Although various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the present description, at least the following matters are described. In the parentheses, the corresponding constituent elements and the like in the above embodiment are shown as examples, but the present invention is not limited thereto.

(1) An information processing device (server 200) for transmitting, to a vehicle (vehicle 100) that autonomously travels to a target parking position (target parking position Ptag) in a parking lot (parking lot PA), first map information (detailed map information DI) of the parking lot used for the autonomous travel, the information processing device including:

a control unit (processor 201) configured to perform processing of:

acquiring scheduled travel route information indicating a scheduled travel route (scheduled travel route RT) for the autonomous travel to the target parking position,

referring to a storage unit (auxiliary storage device 204) configured to store the first map information for each of regions of the parking lot, to specify the first map information of a scheduled travel region including a section overlapping the scheduled travel route based on the scheduled travel route information, and

transmitting the first map information of the scheduled travel region to the vehicle.

According to (1), since only the first map information necessary for the vehicle to autonomously travel to the target parking position in the parking lot can be selectively transmitted to the vehicle, an amount of communication between the information processing device and the vehicle can be reduced while allowing the vehicle to autonomously travel to the target parking position. Therefore, it is possible to improve convenience for a user in the vehicle that autonomously travels in the parking lot using the map information of the parking lot received from the external information processing device.

(2) The information processing device according to (1), in which

when the scheduled travel region includes two or more of the regions, the control unit transmits the first map information to the vehicle in order from the first map information of a region where the vehicle reaches earlier in time series among the two or more regions.

According to (2), since the transmission to the vehicle can be performed in order from the first map information that is needed earlier for the vehicle to autonomously travel to the target parking position, the vehicle can autonomously travel to the target parking position efficiently by sequentially using the received first map information.

(3) The information processing device according to (1), in which

before the vehicle reaches one of the regions included in the scheduled travel region, the control unit transmits the first map information of the one region to the vehicle.

According to (3), before the vehicle reaches one region included in the scheduled travel region, the first map information of the one region can be transmitted to the vehicle, and thus, after reaching the one region, the vehicle can autonomously travel quickly using the first map information of the one region.

(4) The information processing device according to any one of (1) to (3), in which

the control unit transmits second map information (simplified map information SI) representing a simple map of the entire parking lot to the vehicle before the vehicle reaches the parking lot or when the vehicle reaches the parking lot, and

the target parking position is set by a user of the vehicle using the second map information.

According to (4), since the second map information representing the simple map of the entire parking lot is transmitted to the vehicle, the user of the vehicle can set a desired target parking position without transmitting the first map information of the parking lot to the vehicle.

(5) The information processing device according to any one of (1) to (3), in which the control unit

when the scheduled travel route is changed, acquires newly scheduled travel route information indicating a scheduled travel route after change (newly scheduled travel route RTnew),

refers to the storage unit to specify the first map information of a newly scheduled travel region including a section overlapping the scheduled travel route after change based on the newly scheduled travel route information, and

transmits untransmitted first map information among the first map information of the newly scheduled travel region to the vehicle.

According to (5), even when the scheduled travel route is changed for some reason, only the first map information necessary for the vehicle to autonomously travel to the target parking position can be selectively transmitted to the vehicle.

(6) The information processing device according (5), in which

the scheduled travel route is changed based on a detection result of a target (obstacle Ob) present in a periphery of the scheduled travel route or a change in the target parking position.

According to (6), even when the scheduled travel route is changed due to the detection result of the target present in the periphery of the scheduled travel route or the change in the target parking position, only the first map information necessary for the vehicle to autonomously travel to the target parking position can be selectively transmitted to the vehicle.

(7) A vehicle (vehicle 100) that autonomously travels to a target parking position (target parking position Ptag) in a parking lot (parking lot PA) using first map information (detailed map information DI) of the parking lot received from an external information processing device (server 200), the vehicle including:

a reception unit (communication unit 70) configured to receive information transmitted from the information processing device; and

a travel control unit (travel control unit 33) configured to control travel of the vehicle, in which

the reception unit is capable of receiving the first map information of a scheduled travel region including a section overlapping a scheduled travel route (scheduled travel route RT) for the autonomous travel to the target parking position among a plurality of regions of the parking lot, and when the reception unit receives the first map information of the scheduled travel region, the travel control unit performs the autonomous travel to the target parking position using the first map information of the scheduled travel region.

According to (7), since only the first map information necessary for the vehicle to autonomously travel to the target parking position in the parking lot can be received from the information processing device, the amount of communication between the information processing device and the vehicle can be reduced while allowing the vehicle to autonomously travel to the target parking position. Therefore, it is possible to improve the convenience for the user in the vehicle that autonomously travels in the parking lot using the map information of the parking lot received from the external information processing device.

(8) The vehicle according to (7), in which

when the scheduled travel region includes two or more of the regions, the reception unit receives the first map information in order from the first map information of a region where the vehicle reaches earlier in time series among the two or more regions.

According to (8), since the reception from the information processing device can be performed in order from the first map information that is needed earlier for the vehicle to autonomously travel to the target parking position, the vehicle can autonomously travel to the target parking position efficiently by sequentially using the received first map information.

(9) The vehicle according to (7), in which

before the vehicle reaches one of the regions included in the scheduled travel region, the reception unit receives the first map information of the one region.

According to (9), before the vehicle reaches one region included in the scheduled travel region, the first map information of the one region can be received from the information processing device, and thus, after reaching the one region, the vehicle can autonomously travel quickly using the first map information of the one region.

(10) The vehicle according to any one of (7) to (9), in which the vehicle further includes:

a display unit (touch panel 22) configured to display an image; and

a setting unit (setting unit 32) configured to set the target parking position based on an operation received from a user,

the reception unit receives second map information representing a simple map of the entire parking lot from the information processing device before the vehicle reaches the parking lot or when the vehicle reaches the parking lot,

the display unit displays the map based on the second map information received by the reception unit, and

the setting unit sets the target parking position based on an operation received when the map is displayed by the display unit.

According to (10), since the second map information representing the simple map of the entire parking lot is received from the information processing device and the map based on the second map information is displayed, the user of the vehicle can set the desired target parking position by referring to the map, before the first map information is received.

(11) The vehicle according to any one of (7) to (9), in which

when the scheduled travel route is changed, the reception unit receives, from the information processing device, unreceived first map information among the first map information of a newly scheduled travel region including a section overlapping a scheduled travel route after change.

According to (11), even when the scheduled travel route is changed for some reason, only the first map information necessary for the vehicle to autonomously travel to the target parking position can be received from the information processing device.

(12) The vehicle according to (11), in which

the scheduled travel route is changed based on a detection result of a target present in a periphery of the scheduled travel route or a change in the target parking position.

According to (12), even when the scheduled travel route is changed due to some reason such as the detection result of the target present in the periphery of the scheduled travel route or the change in the target parking position, only the first map information necessary for the vehicle to autonomously travel to the target parking position can be received from the information processing device.

(13) An information processing method including a computer (server 200) for transmitting, to a vehicle (vehicle 100) that autonomously travels to a target parking position (target parking position Ptag) in a parking lot (parking lot PA), first map information (detailed map information DI) of the parking lot used for the autonomous travel, performing processing of:

acquiring scheduled travel route information indicating a scheduled travel route for the autonomous travel to the target parking position (step S5);

referring to a storage unit (auxiliary storage device 204) configured to store the first map information for each of regions of the parking lot, to specify the first map information of a scheduled travel region including a section overlapping the scheduled travel route based on the scheduled travel route information (step S6 and step S7); and

transmitting the first map information of the scheduled travel region to the vehicle (step S8).

According to (13), since only the first map information necessary for the vehicle to autonomously travel to the target parking position in the parking lot can be selectively transmitted to the vehicle, the amount of communication between the information processing device and the vehicle can be reduced while allowing the vehicle to autonomously travel to the target parking position. Therefore, it is possible to improve the convenience for the user in the vehicle that autonomously travels in the parking lot using the map information of the parking lot received from the external information processing device.

(14) A program causing a computer (server 200) for transmitting, to a vehicle (vehicle 100) that autonomously travels to a target parking position (target parking position Ptag) in a parking lot (parking lot PA), first map information (detailed map information DI) of the parking lot used for the autonomous travel, to perform processing of:

acquiring scheduled travel route information indicating a scheduled travel route for the autonomous travel to the target parking position (step S5);

referring to a storage unit configured to store the first map information for each of regions of the parking lot, to specify the first map information of a scheduled travel region including a section overlapping the scheduled travel route based on the scheduled travel route information (step S6 and step S7); and

transmitting the first map information of the scheduled travel region to the vehicle (step S8).

According to (14), since only the first map information necessary for the vehicle to autonomously travel to the target parking position in the parking lot can be selectively transmitted to the vehicle, the amount of communication between the information processing device and the vehicle can be reduced while allowing the vehicle to autonomously travel to the target parking position. Therefore, it is possible to improve the convenience for the user in the vehicle that autonomously travels in the parking lot using the map information of the parking lot received from the external information processing device.

1. An information processing device for transmitting, to a vehicle that autonomously travels to a target parking position in a parking lot, first map information of the parking lot used for the autonomous travel, the information processing device comprising:
a processor configured to:
acquire scheduled travel route information indicating a scheduled travel route for the autonomous travel to the target parking position;
refer to a storage unit configured to store the first map information for each of regions of the parking lot, to specify the first map information of a scheduled travel region including a section overlapping the scheduled travel route based on the scheduled travel route information; and
transmit the first map information of the scheduled travel region to the vehicle.

2. The information processing device according to claim 1, wherein
when the scheduled travel region includes two or more regions of the parking lot, the processor transmits the first map information to the vehicle in order from the first map information of a region where the vehicle reaches earlier in time series among the two or more regions.

3. The information processing device according to claim 1, wherein
before the vehicle reaches one of the regions included in the scheduled travel region, the processor transmits the first map information of the one region to the vehicle.

4. The information processing device according to claim 1, wherein
the processor transmits second map information representing a simple map of the entire parking lot to the vehicle before the vehicle reaches the parking lot or when the vehicle reaches the parking lot, and
the target parking position is set by a user of the vehicle using the second map information.

5. The information processing device according to claim 1, wherein
the processor acquires newly scheduled travel route information indicating a scheduled travel route after change when the scheduled travel route is changed,
the processor refers to the storage unit to identify the first map information of a newly scheduled travel region including a section overlapping the scheduled travel route after change based on the newly scheduled travel route information, and
the processor transmits untransmitted first map information among the first map information of the newly scheduled travel region to the vehicle.

6. The information processing device according claim 5, wherein
the scheduled travel route is changed based on a detection result of a target present in a periphery of the scheduled travel route or a change in the target parking position.

7. A vehicle that autonomously travels to a target parking position in a parking lot using first map information of the parking lot received from an external information processing device, the vehicle comprising:
a processor configured to:
receive information transmitted from the information processing device; and
control travel of the vehicle, wherein
the processor is capable of receiving the first map information of a scheduled travel region including a section overlapping a scheduled travel route for the autonomous travel to the target parking position among a plurality of regions of the parking lot, and
when receiving the first map information of the scheduled travel region, the processor performs the autonomous travel to the target parking position using the first map information of the scheduled travel region.

8. The vehicle according to claim 7, wherein
when the scheduled travel region includes two or more regions, the processor receives the first map information in order from the first map information of a region where the vehicle reaches earlier in time series among the two or more regions.

9. The vehicle according to claim 7, wherein
before the vehicle reaches one of the regions included in the scheduled travel region, the processor receives the first map information of the one region.

10. The vehicle according to claim 7, wherein the vehicle further comprises a display configured to display an image, and
the processor sets the target parking position based on an operation received from a user,
the processor receives second map information representing a simple map of the entire parking lot from the information processing device before the vehicle reaches the parking lot or when the vehicle reaches the parking lot,
the display displays the map based on the second map information received by the processor, and
the processor sets the target parking position based on an operation received via the map displayed by the display.

11. The vehicle according to claim 7, wherein
when the scheduled travel route is changed, the processor receives, from the information processing device, unreceived first map information among the first map information of a newly scheduled travel region including a section overlapping a scheduled travel route after change.

12. The vehicle according to claim 11, wherein
the scheduled travel route is changed based on a detection result of a target present in a periphery of the scheduled travel route or a change in the target parking position.

13. An information processing method performed by a computer, wherein
the computer transmits, to a vehicle that autonomously travels to a target parking position in a parking lot, first map information of the parking lot used for the autonomous travel, and
the information processing method comprises:
acquiring scheduled travel route information indicating a scheduled travel route for the autonomous travel to the target parking position;
referring to a storage unit configured to store the first map information for each of regions of the parking lot, to specify the first map information of a scheduled travel region including a section overlapping the scheduled travel route based on the scheduled travel route information; and
transmitting the first map information of the scheduled travel region to the vehicle.

14. A non-transitory computer-readable storage medium storing program for causing a computer to execute a process, wherein
the computer transmits, to a vehicle that autonomously travels to a target parking position in a parking lot, first map information of the parking lot used for the autonomous travel, and
the process comprises:
acquiring scheduled travel route information indicating a scheduled travel route for the autonomous travel to the target parking position; referring to a storage unit configured to store the first map information for each of regions of the parking lot, to specify the first map information of a scheduled travel region including a section overlapping the scheduled travel route based on the scheduled travel route information; and transmitting the first map information of the scheduled travel region to the vehicle.
